(19) United States
(12) Patent Application Publication
(10) Pub. No.: US 2012/0097725 A1
(43) Pub. Date: Apr. 26, 2012

(54) DEVICE FOR ACCOMMODATING ELECTRONIC APPLIANCE FOR VEHICLE

(75) Inventor: Sang Sul Lee, Seongnam (KR)

(73) Assignees: KIA MOTORS CORPORATION, Seoul (KR); HYUNDAI MOTOR COMPANY, Seoul (KR)

(21) Appl. No.: 13/073,770

(22) Filed: Mar. 28, 2011

(30) Foreign Application Priority Data
Oct. 22, 2010 (KR) 10-2010-0103434

(51) Int. Cl. B60R 11/00

(52) U.S. Cl. 224/567

(57) ABSTRACT

A device for accommodating an electronic appliance for a vehicle is provided, which includes a housing having a front surface on which an opening is formed, and assembled on a fascia panel in the neighborhood of a head unit to be synchronized; a tray drawn in/out of the housing through the opening and having a connector installed on one side thereof to be connected to the electronic appliance; a slide unit connected between the housing and the tray to make the tray slidingly move against the housing; and a guide rack integrally prepared on a bottom surface of the tray to gradually pop up the tray up to a predetermined angle as the tray is moved forward for a predetermined distance by the slide unit and then is guided along a guide provided in the housing, and to gradually place the tray downward when the tray is slidingly moved backward.

### CROSS-REFERENCE TO RELATED APPLICATION

This application is based on and claims under 35 U.S.C. §119(a) the benefit of Korean Patent Application No. 10-2010-0103434, filed on Oct. 22, 2010 in the Korean Intellectual Property Office, the disclosure of which is hereby incorporated in its entirety by reference.

### BACKGROUND OF THE INVENTION

1. Field of the Invention

The present invention relates to a device for accommodating an is electronic appliance in a vehicle, and more particularly to a device for accommodating an electronic appliance in a vehicle that is prepared on a fascia panel installed in the neighborhood of a head unit to be synchronized.

2. Description of the Prior Art

Recently, vehicle manufactures have began to provide a dedicated terminal and a stand for installing an electronic appliance (e.g., a smart phone, a portable player, or the like) in the vehicle.

Such an electronic appliance is typically mounted on the inside of a console or glove box on the passenger side of the vehicle. If the electronic appliance is mounted inside the console or glove box, sound transfer is possible, but the transfer efficiency of an image is degraded to cause a moving image reproduction not to be performed smoothly.

For example, Japanese Unexamined Patent Application Publication No. 2008-242259 discloses a structure in which a portable audio appliance is accommodated in an accommodator to be connected to a connector, and the accommodator slidingly moves within a reception chamber that is formed on the right side of a case.

In the apparatus described above, however, the portable audio appliance needs to be taken out from the accommodator in order to see the screen of the portable audio appliance in a state where the accommodator has moved forward, thus causing an inconvenience in use.

### SUMMARY OF THE INVENTION

Accordingly, the present invention has been made to solve the above-mentioned problems occurring in the prior art while at the same time maintaining advantages achieved by the prior art.

The present invention proposes a device for accommodating an electronic appliance for a vehicle, which may smoothly transfer audio and image information and improve a driver's visibility and manipulability of the electronic appliance by providing a fascia panel that is installed in the area of a head unit to be synchronized.

In one aspect of the present invention, there is provided a device for accommodating an electronic appliance for a vehicle, which includes a housing having a front surface on which an opening is formed, and assembled on a fascia panel that is installed in the area of a head unit to be synchronized. Additionally, a tray, drawn in/out of the housing through the opening has a connector installed on one side thereof to be connected to the electronic appliance. A slide unit connected between the housing and the tray may also be utilized to make the tray slidingly move against the housing. Lastly, a guide rack may be integrally prepared on a bottom surface of the tray to gradually pop up the tray up to a predetermined angle as the tray is moved forward for a predetermined distance by the slide unit and then is guided along a guide provided in the housing, and to gradually place the tray downward when the tray is slidingly moved backward.

In some embodiments of the present invention, the guide rack may have a cross-section in the form of a curve and length adjustment member for adjusting the length of the tray may be slidably assembled on a rear end of the tray. The length adjustment member may be inserted into an insertion portion formed on a rear end of a holder. Additionally, an elastic member for pulling the length adjustment member forward may be connected to the length adjustment member in the insertion portion formed on the rear end of the holder. Furthermore, a width adjustment member for adjusting the width of the tray may also be slidably assembled on an inner side surface of the tray.

An elastic member for pressing the width adjustment member inwardly may be connected between the width adjustment member and the side surface of the tray.

The slide unit may further include an upper slider integrally engaged with the gray to slidingly move. The slide unit may also include a lower slider provided on the lower side of the upper slider to slidably guide the upper slider and to slidingly move along the housing, wherein if the tray is pulled forward for a predetermined distance, the upper slider slidingly moves a predetermined distance along the lower slider and then is locked into a first stopper that is formed in front of the lower slider to be stopped, and if the tray is further pulled forward, the lower slider slidingly moves along the housing and then is locked into a second stopper that is formed in front of the housing to be stopped.

In this embodiment, when the lower slider slidingly moves through movement of the tray forward or backward, the tray may be gradually popped up or placed as one operation as the guide rack is guided along the guide without accompanying a separate manipulation.

As described above, according to the device for accommodating an electronic appliance for a vehicle according to an embodiment of the present invention, by preparing and installing a center fascia adjacent to the appliance to be synchronized, the sound and image information is smoothly transferred, and the driver's visibility and manipulability can be improved.

### BRIEF DESCRIPTION OF THE DRAWINGS

The above and other features and advantages of the present invention will be more apparent from the following detailed description taken in conjunction with the accompanying drawings, in which:

FIG. 1 is a view illustrating the state where an electronic appliance is placed on a device for accommodating an electronic appliance for a vehicle according to an exemplary embodiment of the present invention;

FIG. 2 is a perspective view illustrating the state where a tray is closed in the device for accommodating an electronic appliance for a vehicle according to an exemplary embodiment of the present invention;

FIG. 3 is a cross-sectional view illustrating an exemplary slide unit in the exemplary state of FIG. 2;

FIG. 4 is a cross-sectional view illustrating an exemplary guide rack and an exemplary guide in the state of FIG. 2;

FIG. 5 is a perspective view illustrating an exemplary state where a tray is opened forward in a first stage;

FIG. 6 is a cross-sectional view illustrating an exemplary slide unit in the exemplary state of FIG. 5;

FIG. 7 is a cross-sectional view illustrating an exemplary guide rack and an exemplary guide in the exemplary state of FIG. 5;

FIG. 8 is a perspective view illustrating an exemplary state where a tray is opened forward in a second stage;

FIG. 9 is a cross-sectional view illustrating an exemplary slide unit in the exemplary state of FIG. 8;

FIG. 10 is a cross-sectional view illustrating an exemplary guide rack and an exemplary guide in the exemplary state of FIG. 8; and

FIGS. 11 and 12 are views illustrating a length adjustment member and a width adjustment member of a device for accommodating an electronic appliance for a vehicle according to an exemplary embodiment of the present invention.

### DETAILED DESCRIPTION OF THE PREFERRED EMBODIMENTS

Hereinafter, preferred embodiments of the present invention will be described in greater detail with reference to the accompanying drawings.

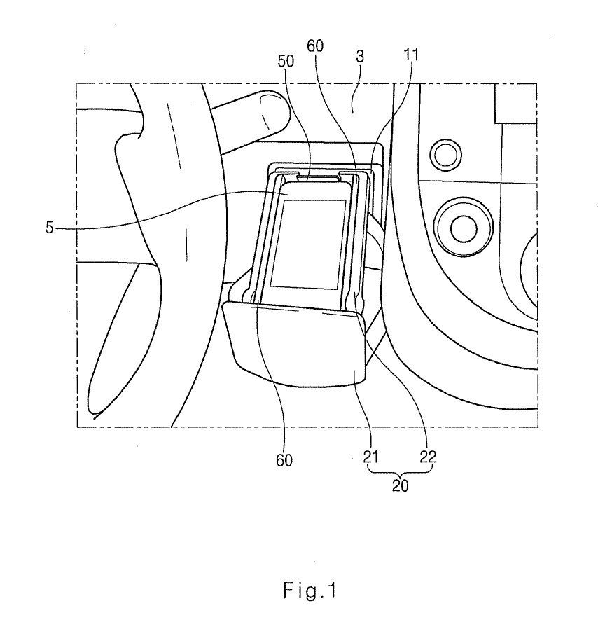

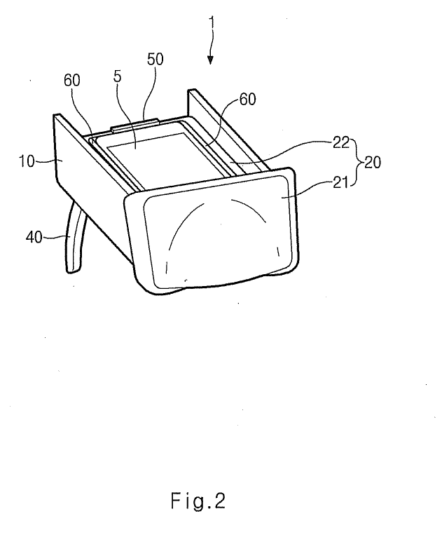

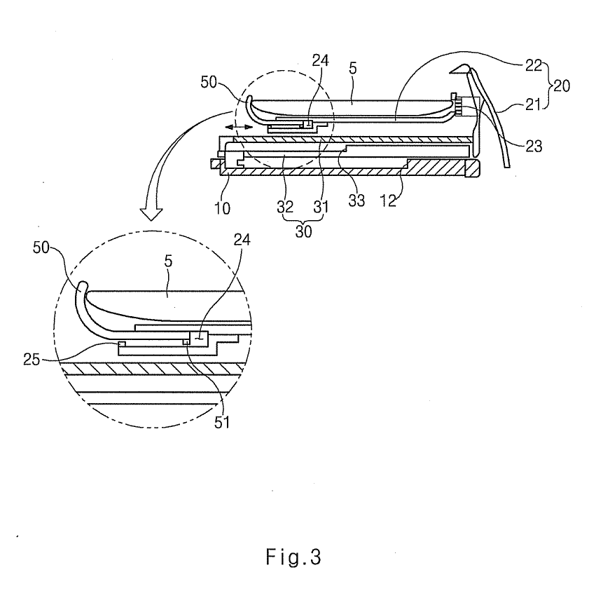

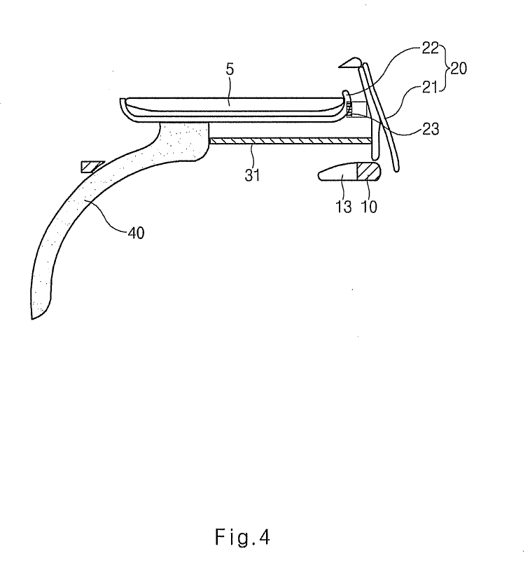

FIG. 1 is a view illustrating an exemplary state where an electronic appliance is placed on a device for accommodating an electronic appliance for a vehicle according to an exemplary embodiment of the present invention. FIG. 2 is a perspective view illustrating the state where a tray is closed in the device for accommodating an electronic appliance for a vehicle according to an embodiment of the present invention, FIG. 3 is a cross-sectional view illustrating a slide unit in the state of FIG. 2, and FIG. 4 is a cross-sectional view illustrating a guide rack and a guide in the state of FIG. 2.

As illustrated in FIGS. 1 to 4, the device 1 for accommodating an is electronic appliance for a vehicle according to an exemplary embodiment of the present invention includes a housing 10 having a front surface on which an opening 11 is formed. The housing is the illustrative embodiment is assembled on a fascia panel 3 that is installed in the neighborhood/area of a head unit (for example, an audio unit, a navigation unit, or the like) to be synchronized. Additionally, a tray 20 on which an electronic appliance (for example, a smart phone or an MP3 player such as an i-pot) 5 is placed which is installed to be drawn in/out of the housing 10 by a slide unit 30 thereby making the tray 20 slidingly move. When the tray 20 is moved for a predetermined distance by the sliding unit 30, a guide rack 40 may pop up or placing the tray 20 into a particular position. The device 1 for accommodating an electronic appliance for a vehicle as configured above according to an embodiment of the present invention is mounted on the fascia panel 3 positioned in front of a driver (e.g., a portion between an audio system and a steering wheel) in the neighborhood/area of the head unit to be synchronized in the vehicle, to smoothly transfer audio and image information to the head unit.

The housing 10 has an opening 11 formed thereon to draw the tray 20 in/out of the housing 10, and is assembled to fit into a mount unit (not illustrated) formed on the fascia panel 3.

In front of the upper surface of the housing 10, a second stopper 12 for deterring a lower slider 32, to be described later, from further moving forward is formed, and on one side of the housing 10, a guide 13 that guides the guide rack 40 for popping up or placing the tray 20 is formed.

Also, on the side surface of the housing 10, it is preferable that a rail is (not illustrated) is formed, on which a lower slider 32, to be described later, slidingly moves.

The tray 20, adapted to allow the electronic appliance 5 to be placed thereon, has a size large enough to cover the opening 11, and is composed of a handle 21, providing a grabbing mechanism for the driver, and a holder 22 formed to extend long from the inner side surface of the handle 21 to the rear side to support the electronic appliance 5.

In front of the upper surface of the holder 22, a connector 23, which may be connected to the electronic appliance 5 to transmit/receive signals with the electronic appliance 5, is installed.

Also, in the rear of the bottom surface of the holder 22, the guide rack 40 is provided, which pops up the holder 22 up to a predetermined angle after the tray 20 is moved forward for a predetermined distance, and places the tray 20 downward when the tray 20 slidingly moves backward.

In the example illustrated in FIG. 4, the guide rack 40 has an exemplary cross-section in the form of a curve, and thus the tray 20 can be gradually popped up to the predetermined angle and placed accordingly when the tray 20 slidingly moves forward or backward,

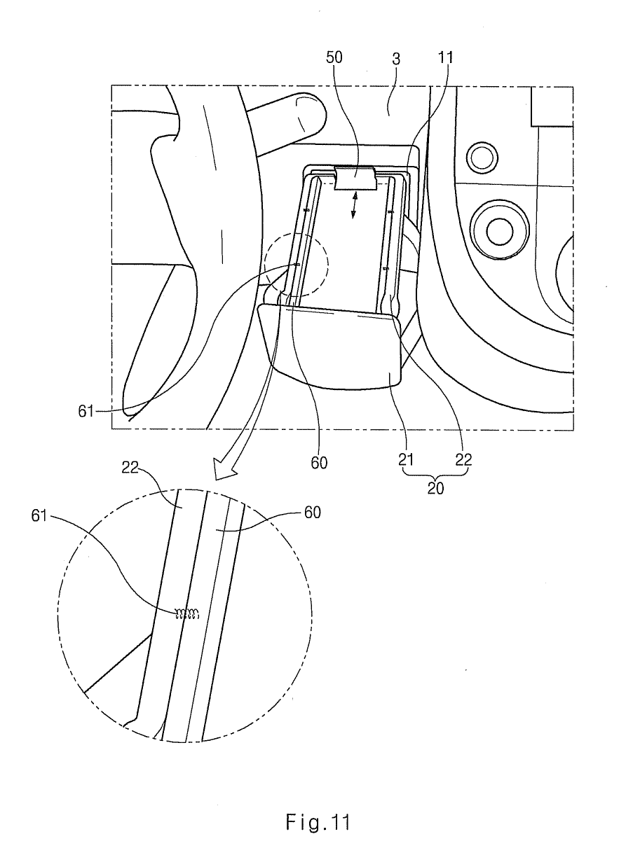

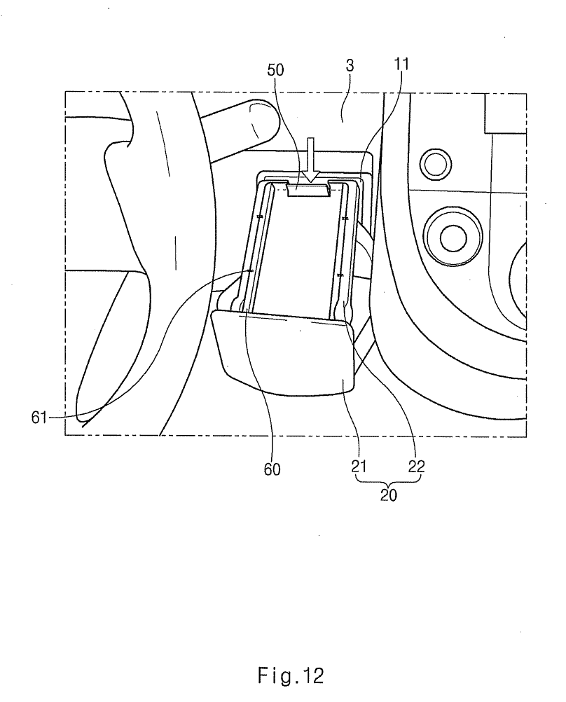

In some embodiments of the present invention, a length adjustment member 50 for adjusting the length of the holder 22 is slidably assembled at the rear end of the holder 22. The length adjustment member 50, as illustrated in FIGS. 11 and 12, may vary the length of the holder 22 so as to accommodate electronic appliances 5 having various sizes, and is inserted into an insertion portion 24 that is formed at the rear end of the holder 22 to slide in the length direction.

That is, in the case of placing an electronic appliance having a long length on the holder 22, the length adjustment member 50 is maximally drawn out as illustrated in FIG. 11, and in the case of placing an electronic appliance having a short length on the holder 22, the length adjustment member 50 is properly drawn in to match the length of the electronic appliance 3 as illustrated in FIG. 12.

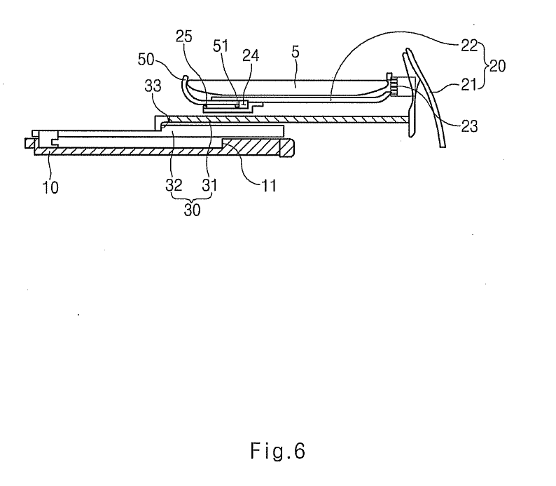

In this case, in front of the bottom surface of the length adjustment member 50, a protrusion 51 is formed, as shown in FIG. 6. This protrusion may be in the rear of the upper surface of the insertion portion 24. Additionally, a locking piece 25, in which the protrusion 51 is locked, is formed so as to prevent the length adjustment member 50 from being further drawn out when the length adjustment member 50 is maximally drawn out.

In addition, although not illustrated in the drawing, an elastic member (not illustrated) that pulls the length adjustment member 50 forward may be connected to the length adjustment member 50 in the insertion portion 24. Accordingly, the length adjustment member 50 can be elastically drawn in/out of the insertion portion 24 by the elastic member in accordance with the length of the electronic appliance.

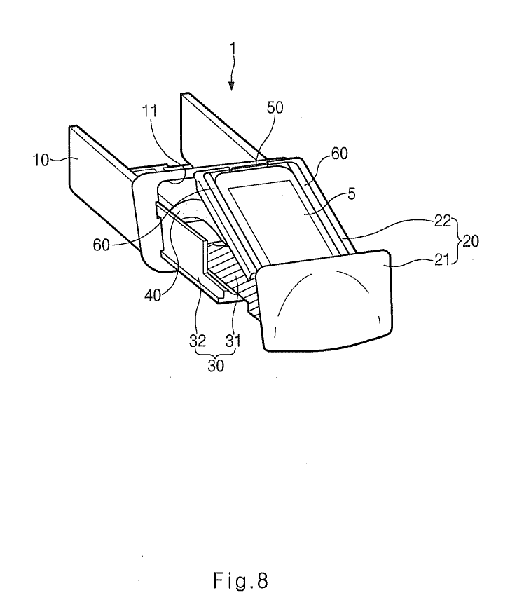

Also, on the inner side surface of the holder 22, a width adjustment member 60 for adjusting the width of the holder 22 is slidably assembled in the exemplary embodiment of the present invention as illustrated in FIGS. 8, 11 and 12. In these embodiments, an elastic member 61 for pressing the width adjustment member 60 inwardly may be connected between the width adjustment member 60 and the side surface of the tray 20.

The width adjustment member 60 may be positioned in a direction in which the width of the holder 22 becomes minimized by the elastic member 61 which may be implemented as a spring. Thus, when an electronic appliance 5 having a large size is placed on the holder 22, the width adjustment member 60 slides outward to match the size of the electronic appliance 5 to adjust the width of the holder 22.

In this embodiment of the present invention, the with adjustment member 60 may be provided on both side surfaces of the holder 22 or on either of the side surfaces of the holder 22. The elastic member 61 may, for example, be composed of a spring, but is not limited thereto, and may be alternatively composed of rubber having elasticity.

The slide unit 30 may also be configured so that the tray 20 may be opened or closed in a second stage by utilizing an upper slider 31 that is integrally engaged with the tray 20, and a lower slider 32 provided below the upper slider 31.

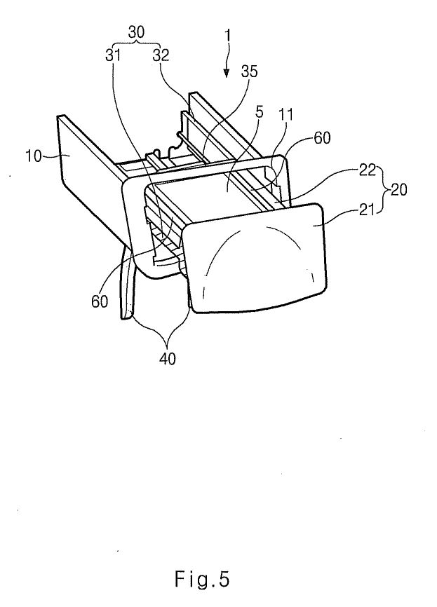

In this exemplary embodiment of the present invention, the upper slider 31 is integrally engaged with the handle 21, and slides along a rail 35 formed in both sides of the lower slider 32. As illustrated in FIGS. 5 and 6, if a driver pulls the tray 20 forward, the upper slider 31 slidingly moves along the rail 35 of the lower slider 32, and the tray 20 is opened in the first stage.

At this time, the rear end of the upper slider 31 is bent downward, and is locked into the first stopper 33 that is formed in front of the lower slider 32.

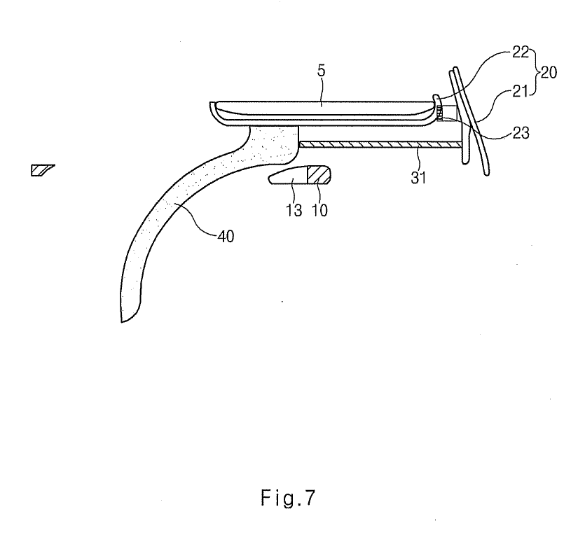

Here, as illustrated in FIGS. 5 and 6, if the upper slider 31 slidingly moves forward and the tray 20 is opened in the first stage, the holder 22 is not popped up and is maintained in a flat state as illustrated in FIG. 7.

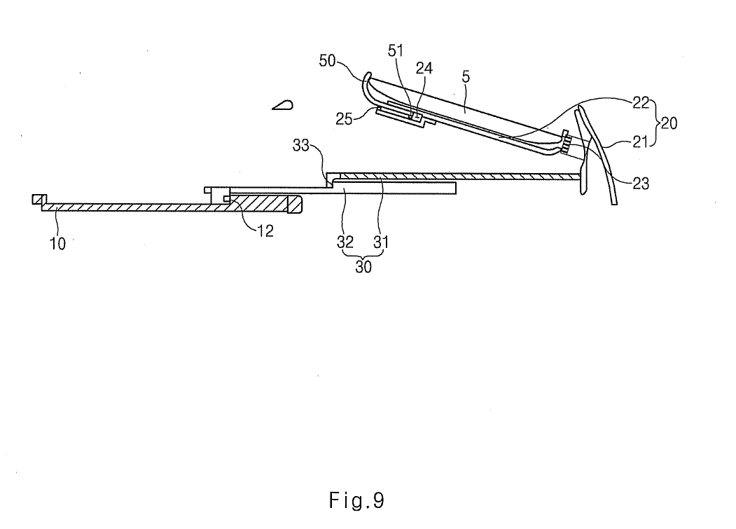

The lower slider 32 serves as a guide to the upper slider 31 as the upper slider 31 slidingly moves along the housing 10. If a driver further pulls the tray 20 forward as illustrated in FIGS. 8 and 9, the upper slider 31, which has been locked into the first stopper 33, is pulled forward to slidingly move along the rail formed on the housing 10, and the tray 20 is completely opened in the second stage.

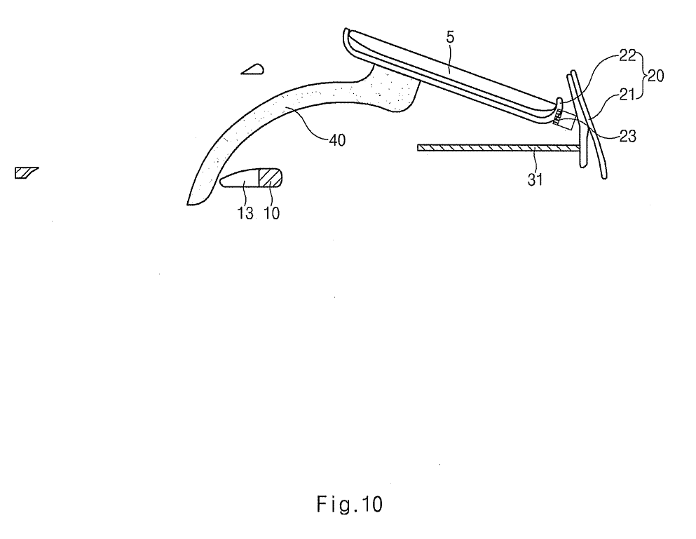

In this case, the rear end of the lower slider 32, which is bent downward, is locked into the second stopper 12 formed in front of the housing 10. Here, as illustrated in FIGS. 8 and 9, in the case where the lower slider 32 slidingly moves forward and the tray 20 is opened in the second stage, even though a user does not make a separate manipulation as illustrated in FIG. 10, the guide rack 40 is guided along the guide 13, and thus the holder 22 is gradually popped up in one operation. As described above, if the tray 20 is completely drawn out forward and the holder is popped up to the predetermined angle, the driver can easily see the electronic appliance 5, resulting in that the visibility and the manipulability can be improved.

On the contrary, in the case where the tray 20 is drawn into the housing 10, the guide rack 40 is guided along the guide 13, even though the user does not make a separate manipulation such as pressing the tray or the like, and the holder gradually moves downward to a placed state. Thereafter, by further moving the tray 20 backward, the opening 11 is closed.

Advantageously, since the device 1 for accommodating an electronic appliance is prepared on the fascia panel 3 and is installed adjacent to the appliance to be synchronized, the sound and image information is smoothly transferred, and the driver's visibility and manipulability can be improved. In addition, when the tray 20 is drawn in/out of the housing 10, the holder 22 is automatically popped up or placed downward, and thus it is convenient in use. In this case, since the tray 20 is configured to be gradually popped up when the tray 20 is opened in the second stage after the opening of the tray 20 in the first stage, the height of the opening 11 can be reduced in comparison to the structure in which the tray 20 is popped up as soon as the tray 20 is opened, and the device is in plain sight of the driver or user.

Although in the above-described embodiments, the slide unit is composed of the upper slider and the lower slider, and the tray is opened/closed through a two-stage process, the slide unit may alternatively be composed of only the upper slider and the tray may be opened/closed through a one-stage process.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A device for accommodating an electronic appliance for a vehicle, comprising:
a housing having a front surface on which an opening is formed, and assembled on a fascia panel that is installed in the neighborhood of a head unit to be synchronized;
a tray configured to be drawn in/out of the housing through the opening and having a connector installed on one side thereof to connect to the electronic appliance;
a slide unit connected between the housing and the tray to make the tray slidingly move against the housing; and
a guide rack integrally prepared on a bottom surface of the tray to gradually pop the tray up to a predetermined angle as the tray is moved forward for a predetermined distance by the slide unit and then is guided is along a guide provided in the housing, and to gradually place the tray downward when the tray is slidingly moved backward.

2. The device for accommodating an electronic appliance according to claim 1, wherein the guide rack has a cross-section in the form of a curve.

3. The device for accommodating an electronic appliance according to claim 2, wherein a length adjustment member for adjusting the length of the tray is slidably assembled on a rear end of the tray.

4. The device for accommodating an electronic appliance according to claim 3, wherein the length adjustment member is inserted into an insertion portion formed on a rear end of a holder, and in the insertion portion, an elastic member for pulling the length adjustment member forward is connected to the length adjustment member.

5. The device for accommodating an electronic appliance according to claim 3, wherein a width adjustment member for adjusting the width of the tray is slidably assembled on an inner side surface of the tray.

6. The device for accommodating an electronic appliance according to claim 5, wherein a elastic member for pressing the width adjustment member inwardly is connected between the width adjustment member and the side surface of the tray.

7. The device for accommodating an electronic appliance according to claim 1, wherein the slide unit further includes an upper slider integrally engaged with the tray to slidingly move.

8. The device for accommodating an electronic appliance according to claim 7, wherein the slide unit further includes a lower slider provided on the lower side of the upper slider to slidably guide the upper slider and to slidingly move along the housing;
wherein if the tray is pulled forward for a predetermined distance, the upper slider slidingly moves for the predetermined distance along the lower slider and then is locked into a first stopper that is formed in front of the lower slider to be stopped, and if the tray is further pulled forward, the lower slider slidingly moves along the housing and then is locked into a second stopper that is formed in front of the housing to be stopped.

9. The device for accommodating an electronic appliance according to claim 8, wherein when the lower slider slidingly moves through movement of the tray forward or backward, and the tray is gradually popped up or placed as one operation as the guide rack is guided along the guide without accompanying a separate manipulation.

10. A device for accommodating an electronic appliance for a vehicle, comprising:
a housing having a front surface on which an opening is formed, and assembled on a fascia panel that is installed in the area of a head unit to be is synchronized;
a tray configured to be drawn in/out of the housing through the opening, the tray having a connector installed on one side thereof to connect to the electronic appliance; and
a guide rack integrally prepared on a bottom surface of the tray to gradually pop the tray up to a predetermined angle as the tray is moved forward for a predetermined distance by a slide unit and then is guided along a guide provided in the housing.

11. The device for accommodating an electronic appliance according to claim 10, wherein the guide rack has a cross-section in the form of a curve.

12. The device for accommodating an electronic appliance according to claim 11, wherein a length adjustment member for adjusting the length of the tray is slidably assembled on a rear end of the tray.

13. The device for accommodating an electronic appliance according to claim 12, wherein the length adjustment member is inserted into an insertion portion formed on a rear end of a holder, and in the insertion portion, an elastic member for pulling the length adjustment member forward is connected to the length adjustment member.

14. The device for accommodating an electronic appliance according to claim 10, wherein the slide unit is connected between the housing and the tray to make the tray slidingly move against the housing, the slide unit further including an upper slider integrally engaged with the tray to slidingly move against the housing.

15. The device for accommodating an electronic appliance according to claim 14, wherein the slide unit further includes a lower slider provided on the lower side of the upper slider to slidably guide the upper slider and to slidingly move along the housing;
wherein if the tray is pulled forward for a predetermined distance, the upper slider slidingly moves for the predetermined distance along the lower slider and then is locked into a first stopper that is formed in front of the lower slider to be stopped, and if the tray is further pulled forward, the lower slider slidingly moves along the housing and then is locked into a second stopper that is formed in front of the housing to be stopped.
